(19) United States
(12) Patent Application Publication
(10) Pub. No.: US 2018/0329946 A1
(43) Pub. Date: Nov. 15, 2018

(54) PERSONAL NARRATIVE ACCESSING SYSTEM

(71) Applicant: Nicholas Gbur, Elk Grove Village, IL (US)

(72) Inventor: Nicholas Gbur, Elk Grove Village, IL (US)

(21) Appl. No.: 15/590,452

(22) Filed: May 9, 2017

(51) Int. Cl. G06F 17/30; G06K 19/06; E04H 13/00; G06K 7/14

(52) U.S. Cl. CPC G06F 17/30386; G06K 7/1443; E04H 13/003; G06K 19/06009

(57) ABSTRACT

A personal narrative accessing system includes a database having a dataset is stored therein associated with a person's history. A machine readable code is provided that associated with one of the dataset. A gravestone has the machine readable code mounted thereon. A cellular phone includes a housing and a processor, transmitter, display and camera mounted in the housing and being electrically coupled together. The display also comprises an input interface. The processor is programmed with an application in wireless communication with the database. The camera creates an image of the machine readable code and the processor transmits the image to the database such that the database accesses the dataset associated with the image to define an associated dataset. The associated dataset is transmitted to the processor and is arranged into a readable format that is viewable on the display.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to personalized memorial systems and more particularly pertains to a new personalized memorial system for allowing interested persons to access a historical narrative, photos and the like of a deceased person as well as to cross-link the deceased person's history with persons connected to the deceased.

### BRIEF SUMMARY OF THE INVENTION

An embodiment of the disclosure meets the needs presented above by generally comprising a database having a dataset is stored therein associated with a person's history. A machine readable code is provided that associated with one of the dataset. A gravestone has the machine readable code mounted thereon. A cellular phone includes a housing and a processor, transmitter, display and camera mounted in the housing and being electrically coupled together. The display also comprises an input interface. The processor is programmed with an application in wireless communication with the database. The camera creates an image of the machine readable code and the processor transmits the image to the database such that the database accesses the dataset associated with the image to define an associated dataset. The associated dataset is transmitted to the processor and is arranged into a readable format that is viewable on the display.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a machine readable code of a personal narrative accessing system according to an embodiment of the disclosure.

FIG. 2 is a back view of a panel of an embodiment of the disclosure.

FIG. 3 is a perspective in-use view of an embodiment of the disclosure.

FIG. 4 is a schematic view of an embodiment of the disclosure.

### DETAILED DESCRIPTION OF THE INVENTION

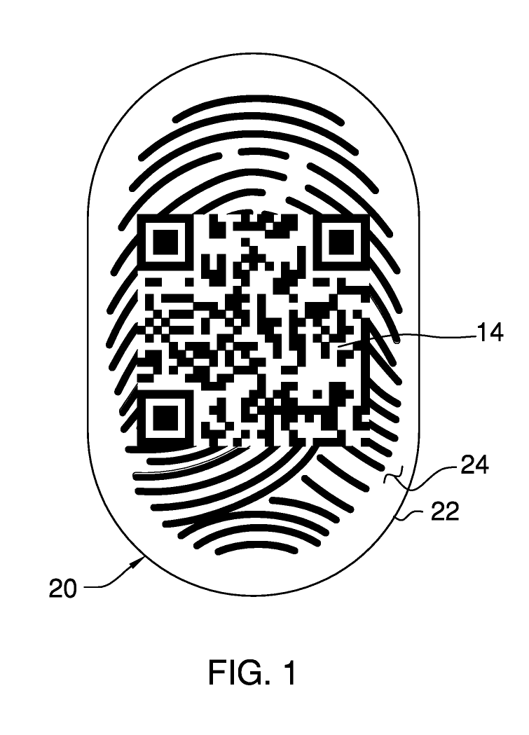

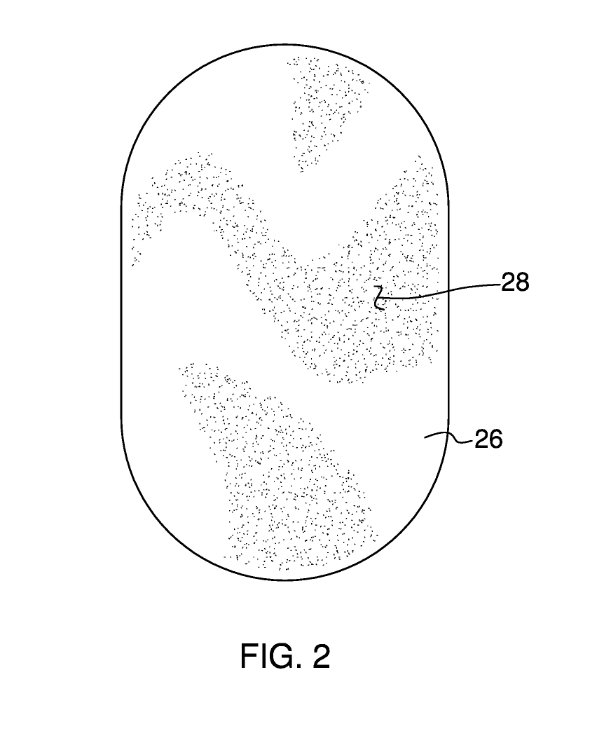

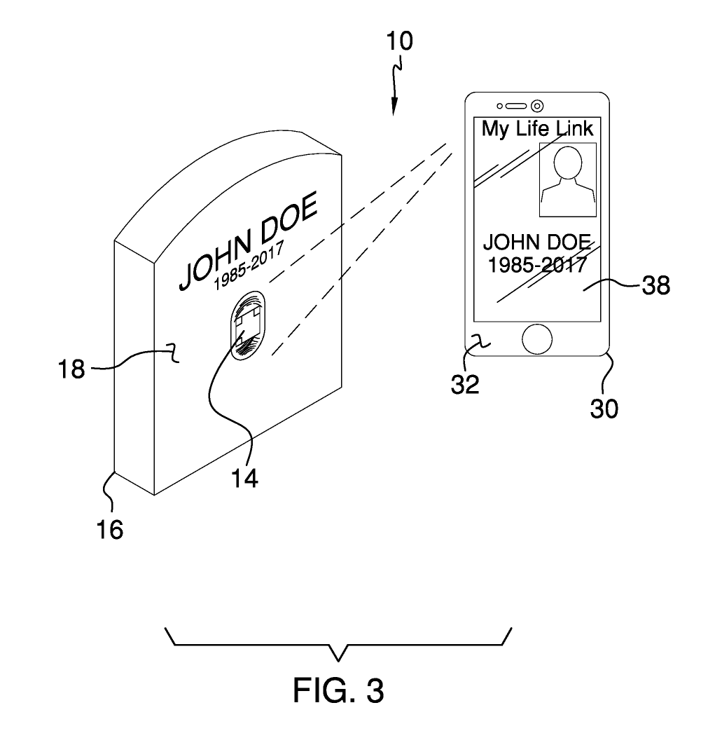

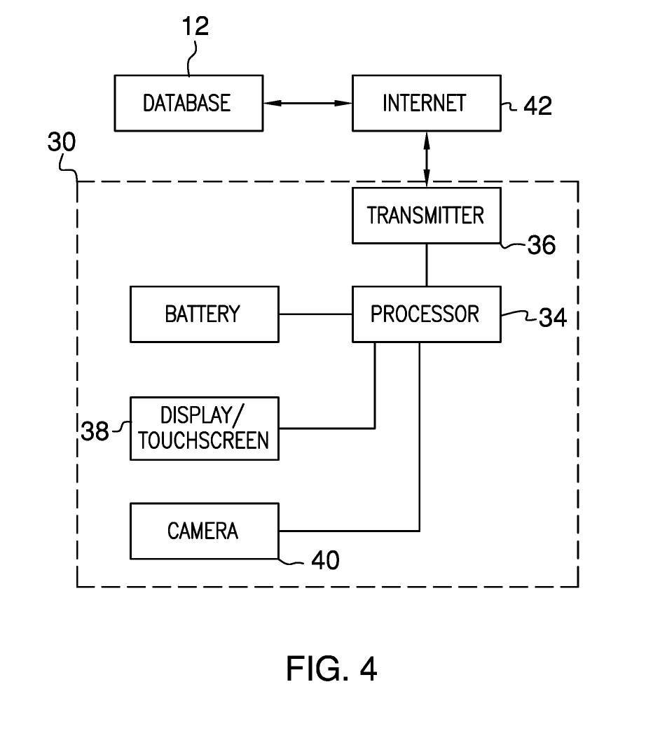

With reference now to the drawings, and in particular to FIGS. 1 through 4 thereof, a new personalized memorial system embodying the principles and concepts of an embodiment of the disclosure and generally designated by the reference numeral 10 will be described.

As best illustrated in FIGS. 1 through 4, the personal narrative accessing system 10 generally comprises a database 12 having a plurality of datasets that are stored therein. Each of the datasets is associated with a history of a person such that multiple histories of a persons are stored in the database. More specifically, each history is a memorial or narrative of a person's life and even more specifically of a deceased person. Further, the datasets may be linked to each other should there be a connection between the datasets. Thus, one dataset may contain the history of a first person and a second dataset may contain the history of a second person who was the spouse of the first person. When either the first or second dataset is accessed, the viewer of the history will be able to crosslink the other one of the first or second datasets to get a fuller understanding of a person's life. The system 10 may programmed to link datasets bases on any number of parameters including familial connections, friendships, life experiences (attended schools at a similar time, served within a particular subset of a military branch at the same time), and the like.

A plurality of machine readable codes 14 is provided and each of the machine readable codes is associated with one of the dataset so that each dataset has its own unique machine readable code. The machine readable code 14 may comprise barcode such as 1D or 2D barcode, though 2D barcode, often referred to as a QR Code, may be preferred due to its ability to encode a greater amount of information. The machine readable code 14 may be mounted on a marker such as, for instance, a gravestone 16 having an outer surface 18. The machine readable code 14 on the gravestone 16 will associate the person in a grave marked by the gravestone 16 to that person's dataset to define an associated dataset. Because of the crosslinking available, the associated dataset may include directions to nearby gravestones 16 which also have machine readable codes 14 thereon which include dataset histories having connections with the person in the grave.

A plurality of substrates 20 may be provided and each of the substrates 20 has one of the machine readable codes 16 positioned thereon. More particularly, each of the substrates 20 may comprise a panel 22 having a front side 24 and a back side 26. The panels 22 may be comprised of a flexible material or a rigid material depending upon usage. The front side 24 of each of the panels 22 has an associated one of the machine readable codes 14 thereon and an adhesive 28 is positioned on each of the back sides 26 of each of the panels 22. One of the panels 22 is adhered to the outer surface 18 of the gravestone 16. The machine readable code 14 on the panel 22 adhered to the gravestone 16 will of course associate the gravestone 16, and the person it is marking in a grave, to the dataset for that person marked by the gravestone. However, by utilizing the panels 22, a plurality of the panels 22 having the same machine readable code 14 thereon may be printed so that they might be handed out, adhered to cards, made into a plant or tree type assembly and the like so that people may take and keep the machine readable code 14 to access the associated dataset as desired. Alternatively, the panels 22 may be mounted on other articles as well such as mausoleums, caskets, and the like.

A device is required for scanning and the machine readable code 14 and accessing the associated dataset form the database 12. In particular, one such device may comprise a cellular phone 30 that includes a housing 32 having a processor 34, transmitter 36 and display 38 mounted therein and electrically coupled together. The display 38 also comprises an input interface or touchscreen. A camera 40 is mounted on the housing 32 and is electrically coupled to the processor 34. The camera 40 is configured to take an image of one of the machine readable codes 14. The above is a conventional cellular phone which have been used for scanning barcodes utilizing a built-in camera. The processor 34 is programmed with an application, or program, which is in wireless communication with the database 12 utilizing a cellular signal or wi-fi signal via the internet 42, typically. The processor 34 transmits the image to the database 12 such that the database 12 accesses the dataset associated with the image to define the associated dataset. The associated dataset is transmitted to the processor 34. The associated dataset, by way of the application, is arranged into a readable format and is viewable on the display 38. The associated dataset may include, for example, one or more photographs of the person, the person's history including schooling, work, achievements, family connection and the like, as well as connections to others who have datasets that may also be accessed.

In use, the system 10 may be used to image a machine readable code 14 so that the person scanning the code may view the associated dataset. In this way, a user of the system 10 will be provided with an in-depth history of a deceased person and may further access the histories of those people who have been a part of the deceased person's life.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An information accessing system configured to allow personal history to be selectively accessed, said system comprising:
a database having a dataset being stored therein associated with a history of a person;
a machine readable code being associated with one of said dataset;
a gravestone having said machine readable code mounted thereon; and
a cellular phone including a housing, a processor being mounted in said housing and being electrically coupled to a transmitter in said housing, a display being mounted on said housing and being electrically coupled to said transmitter, said display also comprising an input interface, said processor being programmed with an application in wireless communication with said database, a camera being mounted on said housing and being electrically coupled to said processor, said camera being configured to take an image of said machine readable code, said processor transmitting said image to said database such that said database accesses said dataset associated with said image to define an associated dataset, said associated dataset being transmitted to said processor, said associated dataset being arranged into a readable format and being viewable on said display.

2. The information accessing system according to claim 1, further including a substrate having a front side and a back side, said machine readable code being positioned on said front side.

3. The information accessing system according to claim 2, said substrate comprising a panel having said front side and said back side, an adhesive being positioned on said back side of each of said panel.

4. An information accessing system configured to allow personal history to be selectively accessed, said system comprising:
a database having a plurality of datasets being stored therein, each of said datasets being associated with a history of a person such that multiple histories of persons are stored in said database;
a plurality of machine readable codes, each of said machine readable codes being associated with one of said datasets;
a plurality of substrates, each of said substrates having one of said machine readable codes positioned thereon, each of said substrates comprising a panel having a front side and a back side, said front side of each of said panels having an associated one of said machine readable codes thereon, an adhesive being positioned on each of said back sides of each of said panels;
a gravestone having an outer surface, one of said panels being adhered to said outer surface of said gravestone, said machine readable code positioned on said panel adhered to said gravestone associating one of said datasets to said gravestone; and
a cellular phone including a housing, a processor being mounted in said housing and being electrically coupled to a transmitter in said housing, a display being mounted on said housing and being electrically coupled to said transmitter, said display also comprising an input interface, said processor being programmed with an application in wireless communication with said database, a camera being mounted on said housing and being electrically coupled to said processor, said camera being configured to take an image of one of said machine readable codes, said processor transmitting said image to said database such that said database accesses said dataset associated with said image to define an associated dataset, said associated dataset being transmitted to said processor, said associated dataset being arranged into a readable format and being viewable on said display.
